(19) United States
(12) Patent Application Publication
(10) Pub. No.: US 2015/0330300 A1
(43) Pub. Date: Nov. 19, 2015

(54) TWO SPOOL ENGINE CORE WITH A STARTER

(71) Applicant: UNITED TECHNOLOGIES CORPORATION, Hartford, CT (US)

(72) Inventors: Gabriel L. Suciu, Glastonbury, CT (US); Brian D. Merry, Andover, CT (US)

(73) Assignee: UNITED TECHNOLOGIES CORPORATION, Hartford, CT (US)

(21) Appl. No.: 14/142,965

(22) Filed: Dec. 30, 2013

Related U.S. Application Data
(60) Provisional application No. 61/781,705, filed on Mar. 14, 2013.

(51) Int. Cl. F02C 3/10; F02C 7/27

(52) U.S. Cl. CPC F02C 3/10; F02C 7/27

(57) ABSTRACT

A gas turbine engine has a first spool, a second spool, and a one-way clutch connecting the first and second spools. The one-way clutch disengages from the second spool when the first and second spools rotate at a predetermined speed.

### CROSS REFERENCE TO RELATED APPLICATION(S)

This application claims the benefit of provisional application Ser. No 61/781,705, filed Mar. 14, 2013.

### BACKGROUND

The present disclosure is directed to a two spool engine core having a starter attached to a low pressure compressor rotor and a one way clutch connecting a low spool to a high spool.

Gas turbine engines require a starter to initiate operation of the engine. The engine starter is typically connected to a high pressure spool of the engine via a tower shaft and an accessory gear box.

In traditional gas turbine engines, such as three spool engines, the high compressor is larger than the intermediate pressure compressor. Typically, the high pressure compressor has a pressure ratio of about 4.5 and the intermediate pressure compressor has a pressure ratio of about 8. This provides a ratio of about 1:1 to 2:1.

### SUMMARY

In accordance with the present disclosure, there is provided an engine which broadly comprises a first spool and a second spool; and a one-way clutch connecting the first and second spools, the one-way clutch disengaging from the second spool when the second spool and the first spool rotate at a predetermined speed.

In another and alternative embodiment, the first spool is a low spool and the second spool is the high spool and wherein the predetermined speed is a speed at which the high spool rotates faster than the low spool.

In another and alternative embodiment, a combustor burns fuel at the predetermined speed.

In another and alternative embodiment, the engine further comprises a starter connected to a tip of the low spool and the starter providing initial torque to the high and low spools, whereby the high and low spools rotate substantially from rest to the predetermined speed at the same speed.

In another and alternative embodiment, the starter is located at an axial tip of the low spool.

In another and alternative embodiment, the engine has a low pressure compressor having a rotor and the starter is mounted to the rotor of the low pressure compressor.

In another and alternative embodiment, the starter is an electrical starter.

In another and alternative embodiment, the starter is a pneumatic starter.

In another and alternative embodiment, the engine further comprises an oil pump, a fuel pump, the starter acting as a generator, and a shaft connected to low pressure compressor gear located in between the starter acting as the generator and an inlet to a low pressure compressor to extract shaft horsepower to run the oil and fuel pumps.

In another and alternative embodiment, the starter functions as a generator for powering electrical components.

In another and alternative embodiment, excess power from the starter is delivered to an airframe to operate electronics.

In another and alternative embodiment, the engine is a reverse engine core.

In another and alternative embodiment, the engine further comprises a low pressure compressor and a high pressure compressor and the low pressure compressor being larger in size than the high pressure compressor.

In another and alternative embodiment, the ratio of low pressure compressor pressure ratio to high pressure compressor pressure ratio is in a range of from greater than 2:1 to 4:1.

Further in accordance with the present disclosure, there is provided a propulsion system which broadly comprises a propulsor comprising a free turbine and a fan driven by the free turbine; a two spool engine for providing exhaust fluid for driving the free turbine; the two spool engine having a first spool and a second spool; and a one-way clutch connecting the first and second spools, the one-way clutch disengaging from the second spool when the second spool and the first spool rotate at a predetermined speed.

In another and alternative embodiment, the first spool is a low spool, the second spool is a high spool, and the predetermined speed is when the second spool begins to rotate at a speed faster than the first spool.

In another and alternative embodiment, a combustor burns fuel at the predetermined speed.

In another and alternative embodiment, the propulsion system further comprises said engine having a low pressure compressor and a low pressure turbine connected by the low spool, a high pressure compressor and a high pressure turbine connected by the high spool, a combustor positioned between the high pressure compressor and the high pressure turbine, and the one-way clutch disengaging from the high spool when the combustor lights and burns fuel and the high spool rotates faster than the low spool so that the high spool rotates freely.

In another and alternative embodiment, the propulsion system further comprises a diverter valve for diverting the exhaust fluid away from the free turbine so that the engine operates as an auxiliary power unit during ground idle.

In another and alternative embodiment, the propulsion system further comprises a propulsor accessory gear box connected to the free turbine.

In another and alternative embodiment, the propulsion system further comprises a core accessory gear box connected to the second spool.

In another and alternative embodiment, the two spool engine comprises a reverse engine core and is a line replaceable unit.

In another and alternative embodiment, the propulsion system further comprises a starter connected to the first spool and the starter providing initial torque to the first and second spools, whereby the first and second spools rotate at the same speed substantially from rest to the predetermined speed.

In another and alternative embodiment, the engine further comprises a low pressure compressor having a rotor and the starter being mounted to the rotor of the low pressure compressor.

In another and alternative embodiment, the engine further comprises a low pressure compressor and a high pressure compressor and the low pressure compressor being larger in size than the high pressure compressor.

In another and alternative embodiment, a ratio of low pressure compressor pressure ratio to high pressure compressor pressure ratio is in a range of from greater than 2:1 to 4:1.

Other details of the two spool engine core with a starter are set forth in the following detailed description and the accompanying drawings wherein like reference numerals depict like elements.

### BRIEF DESCRIPTION OF THE DRAWINGS

FIG. 1 is a section view of a propulsion system mounted beneath a wing of an aircraft;

FIG. 2 is a schematic representation of a first embodiment of a two spool engine core having a starter;

FIG. 3 is a schematic representation of a clutch positioned between the low spool and the high spool;

FIG. 4 is a schematic representation of a system for driving oil and fuel pumps for the engine core;

FIG. 5 is a schematic representation of a generator attached to the free turbine; and

FIG. 6 is a schematic representation of an alternative embodiment of a two spool engine core having a starter and a diverter valve.

### DETAILED DESCRIPTION

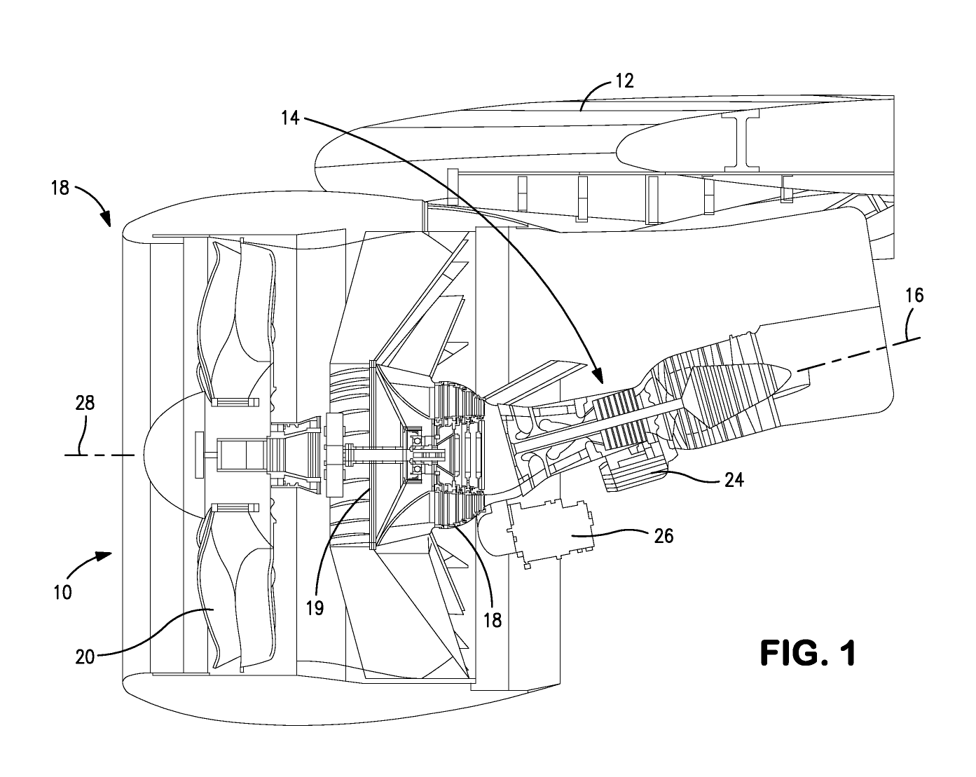

Referring now to FIG. 1, there is shown a propulsion system 8 mounted beneath a wing 12 of an aircraft. The propulsion system 8 includes a two spool reverse gas generator, that is, engine 14 which has a centerline 16 about which several engine core components rotate.

The propulsion system 8 has a propulsor 10 which includes a free turbine or power turbine 18 which is driven by the exhaust flow from the engine core 14. The propulsion system 8 also has a fan 20 having a plurality of fan blades 22 connected to the free turbine or power turbine 18 via the shaft 19.

The engine core 14 has a core accessory gear box 24 which may be connected to a high pressure spool core via a shaft (not shown). The propulsor 10 has a propulsor accessory gear box 26 connected to the free turbine 18 by a shaft (not shown). The accessory gear boxes 24 and 26 may be used to operate pumps, electrical devices, electronics, and other components associated with the engine core 14 and the propulsor 10. The free turbine 18 and the fan 20 rotate about a centerline 28 which may be angled with respect to the centerline 16.

Advantages of the engine core 14 described herein is that it does not have any mechanical connections to the propulsor 10 that need to be removed in order to remove the engine core 14. The only connection between the engine core 14 and the propulsor 10 is an aerodynamic connection. That is, as illustrated in FIG. 1, exhaust from the engine core 14 drives the free turbine 18; no other direct mechanical connection is required. In addition, the engine core 14 may be taken out of the propulsion system 8 in its entirety when repairs are needed and replaced by another engine core. Thus, the engine core 14 is what is termed a line replaceable unit.

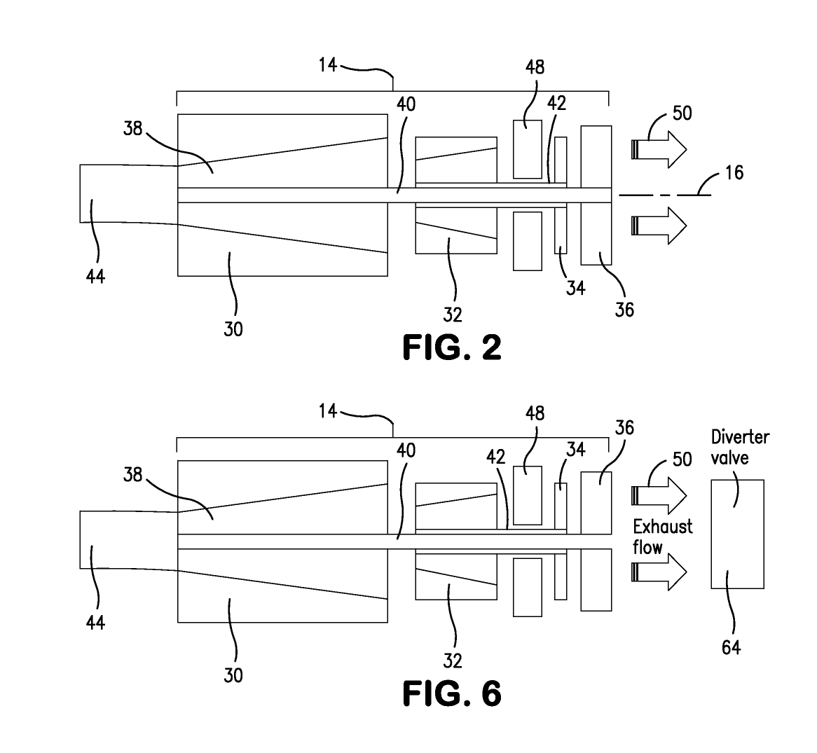

Referring now to FIG. 2, there is schematically shown the components of the engine core 14. As can be seen from this figure, the engine core 14 includes a low pressure compressor 30, a high pressure compressor 32, a high pressure turbine 34, and a low pressure turbine 36 which rotate about the centerline 16. The low pressure compressor 30 has a rotor 38 and is connected to the low pressure turbine 36 by the low spool 40. The high pressure compressor 32 is connected to the high pressure turbine 34 by a high spool 42 which surrounds the low spool 40. Each of the low pressure compressor 30, the high pressure compressor 32, high pressure turbine 34, and low pressure turbine 36 has a plurality of rows or stages of blades and vanes. A combustor 48 is located between the high pressure compressor 32 and the high pressure turbine 34.

As can be seen from FIG. 2, the low pressure compressor 30 is larger in size than the high pressure compressor 32 and the low pressure turbine 36 is larger in size than the high pressure turbine 34. By larger in size, it is meant that the low pressure turbine 36 and the low pressure compressor 30 have a greater axial length, diameter, and/or number of stages than the high pressure turbine 34 and the high pressure compressor 32. The ratio of the low compressor pressure ratio to the high compressor pressure ratio may be in the range of greater than 2:1 to 4:1.

A starter/permanent magnet alternator 44 is located at a tip (compressor side) of the low spool 40. The starter/permanent magnet alternator 44 may be attached to the low compressor rotor 38. The starter/permanent magnet alternator 44 provides initial torque for starting the engine core 14. The permanent magnet alternator 44 provides power to electronics (not shown) associated with the engine core 14.

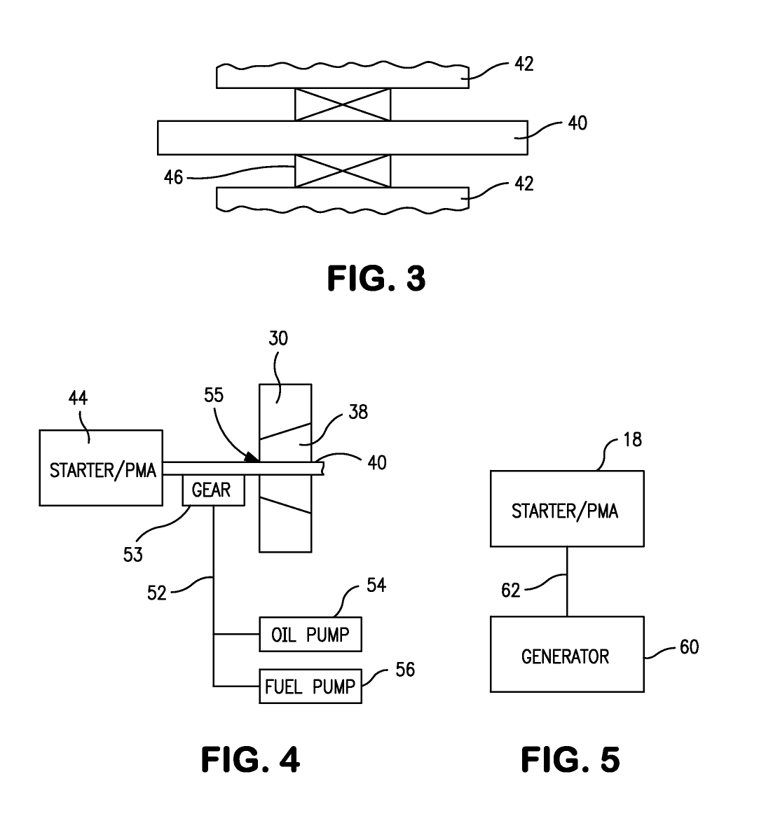

As shown in FIG. 3, the high spool 42 is connected to the low spool 40 by a ratchet type one way clutch 46. Both spools 40 and 42 spin at the same speed, under power of the starter 44, until the high spool lights up first. This typically occurs about 10% to 15% of normal rotational speed for the engine core 14, but may occur at a different rotational speed depending on the engine architecture. By normal rotational speed, it is meant the speed at which the high spool 42 rotates during normal operation of the engine core 14. The one way clutch 46 disengages as the combustor 48 lights and burns fuel and the high spool rotates faster than the low spool so as to enable the high spool 42 to spin freely of the low spool.

The exhaust flow 50 exiting the low pressure turbine 36 is directed to the free turbine 18 for driving same.

One advantage to the design of the engine core 14 is that a smaller starter 44 can be used to start the engine core 14. Further, there is no need for a tower shaft as in prior engine configurations. Other advantages are that the starter 44 may be a line replaceable unit and may be either electrical or pneumatic depending upon its intended operation.

The starter/permanent magnet alternator (PMA) 44 may be electrical and sized to provide engine needs only such as an oil pump and a fuel pump. The starter/permanent magnet alternator 44 may be compatible with a pneumatic starter. A towershaft 52 may be provided to extract shaft horsepower to run an oil pump 54 and a fuel pump 56. As shown in FIG. 4, the towershaft 52 may be connected to low pressure compressor gear 53 located in between the starter/PMA 44 and an inlet 55 to the low pressure compressor 30. By doing this, the starter/permanent magnet alternator 44 may function as a starter/generator. The starter 44 acting as a generator, from spinning with the low spool 40, can power the engine oil pump 54 and the fuel pump 56. The starter 44 may also produce electricity and provide it to the engine 14. Additional power coming from the free turbine 18 and/or the aircraft can be used to power the oil and fuel pumps. This enables the engine core 14 to be self sufficient during flight and not require an auxiliary power unit (APU) to drive the oil pump 54 and the fuel pump 56.

If needed, the low pressure compressor 30 may have bleed holes if needed, shaft horsepower extraction, and variable stages. The high pressure compressor 32 may have no variable stages, no bleed holes, and no shaft horsepower extraction.

The starter/permanent magnet alternator 44, in another non-limiting embodiment, may be sized for all electric operation to (a) support engine needs such as an oil pump or fuel pump, and (b) deliver excess power to the airframe electronics. If additional power is needed beyond the capability of the two spool engine core 14, then an additional generator 60 may be connected to the free turbine 18 via a shaft 62 as shown in FIG. 5. The additional generator 60 may be a variable speed generator with a gear ratio from 2:1 to 5:1.

Referring now to FIG. 6, there is shown an alternative embodiment of a two spool engine core 14 similar to the one shown in FIG. 2. The embodiment shown in FIG. 5 includes a diverter or bypass valve 64 to divert exhaust flow away from the free turbine 18 during ground idle. The exhaust flow diverted by the diverter valve 64 may be dumped to the atmosphere, towards the free stream flow direction. By diverting the exhaust flow 50 and spoiling the fan thrust, the need to use airplane brakes while at an airport gate is eliminated. During normal operation, the diverter or bypass valve 64 may be closed so as to direct the exhaust flow to the free turbine 18, to drive rotation of the fan 20. With the diverter activated, however, the two spool engine core 14 may be used as an APU unit without producing fan thrust to produce electric power.

There has been provided a two spool engine core with a starter. While the two spool engine core with the starter has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. An engine comprising:
a first spool and a second spool; and
a one-way clutch connecting said first and second spools, said one-way clutch disengaging from said second spool when the second spool and the first spool rotate at a predetermined speed.

2. The engine according to claim 1, wherein the first spool is a low spool and the second spool is the high spool and wherein the predetermined speed is a speed at which the high spool rotates faster than the low spool.

3. The engine according to claim 1, wherein a combustor burns fuel at the predetermined speed.

4. The engine of claim 2, further comprising a starter connected to a tip of said low spool and said starter providing initial torque to said high and low spools, whereby said high and low spools rotate substantially from rest to said predetermined speed at the same speed.

5. The engine according to claim 4, wherein said starter is located at an axial tip of said low spool.

6. The engine of claim 4, wherein said engine has a low pressure compressor having a rotor and said starter is mounted to said rotor of said low pressure compressor.

7. The engine of claim 4, wherein said starter is an electrical starter.

8. The engine of claim 4, wherein said starter is a pneumatic starter.

9. The engine of claim 4, further comprising an oil pump, a fuel pump, said starter acting as a generator, and a shaft connected to low pressure compressor gear located in between the starter acting as the generator and an inlet to a low pressure compressor to extract shaft horsepower to run said oil and fuel pumps.

10. The engine of claim 4, wherein said starter functions as a generator for powering electrical components.

11. The engine of claim 4, wherein excess power from said starter is delivered to an airframe to operate electronics.

12. The engine of claim 4, wherein said engine is a reverse engine core.

13. The engine of claim 1, further comprising a low pressure compressor and a high pressure compressor and said low pressure compressor being larger in size than said high pressure compressor.

14. The engine of claim 13, wherein the ratio of low pressure compressor pressure ratio to high pressure compressor pressure ratio is in a range of from greater than 2:1 to 4:1.

15. A propulsion system comprising:
a propulsor comprising a free turbine and a fan driven by said free turbine;
a two spool engine for providing exhaust fluid for driving said free turbine;
said two spool engine having a first spool and a second spool; and
a one-way clutch connecting said first and second spools, said one-way clutch disengaging from said second spool when said second spool and said first spool rotate at a predetermined speed.

16. The propulsion system of claim 15, wherein said first spool is a low spool, said second spool is a high spool, and said second spool rotates at a speed faster than said first spool.

17. The propulsion system of claim 15, wherein said engine has a combustor burning fuel at the predetermined speed.

18. The propulsion system of claim 16, further comprising said engine having a low pressure compressor and a low pressure turbine connected by said low spool, a high pressure compressor and a high pressure turbine connected by said high spool, a combustor positioned between said high pressure compressor and said high pressure turbine, and said one-way clutch disengaging from said high spool when said combustor lights and fuel burns and said high spool rotates faster than said low spool so that said high spool rotates freely.

19. The propulsion system according to claim 15, further comprising a diverter valve for diverting said exhaust fluid away from said free turbine so that said engine operates as an auxiliary power unit during ground idle.

20. The propulsion system according to claim 15, further comprising a propulsor accessory gear box connected to said free turbine.

21. The propulsion system according to claim 15, further comprising a core accessory gear box connected to said second spool.

22. The propulsion system according to claim 15, wherein said two spool engine comprises a reverse engine core and is a line replaceable unit.

23. The propulsion system according to claim 15, further comprising a starter connected to said first spool and said starter providing initial torque to said first and second spools, whereby said first and second spools rotate at the same speed substantially from rest to said predetermined speed.

24. The propulsion system of claim 23, further comprising said engine having a low pressure compressor having a rotor and said starter being mounted to said rotor of said low pressure compressor.

25. The propulsion system of claim 15, further comprising said engine having a low pressure compressor and a high pressure compressor and said low pressure compressor being larger in size than said high pressure compressor.

26. The propulsion system of claim 25, wherein said engine has a ratio of low pressure compressor pressure ratio to high pressure compressor pressure ratio is in a range of from greater than 2:1 to 4:1.
